(19) United States
(12) Patent Application Publication
(10) Pub. No.: US 2010/0003118 A1
(43) Pub. Date: Jan. 7, 2010

(54) Cotton Module Plastic Wrapping Material And Module Hangler For Optimizing Module Rotation For Wrapping Removal

(76) Inventors: James Thomas Noonan, Bondurant, IA (US); Jerry Bob Hall, Johnston, IA (US); Mark Alan Cracraft, Urbandale, IA (US)

Correspondence Address: DEERE & COMPANY, ONE JOHN DEERE PLACE, MOLINE, IL, 61265, US

(21) Appl. No.: 12/165,673

(22) Filed: Jul. 1, 2008

(51) Int. Cl. B65B 13/02; H04Q 5/22

(52) U.S. Cl. 414/757; 340/10.1

(57) ABSTRACT

A supply of plastic wrapping material for wrapping cylindrical modules includes a plurality of end-to-end segments, with each segment being of a length sufficient for enveloping a cylindrical cotton module of a given size with a predetermined number of layers of wrapping. All except an inner tail of an inner layer of wrapping adheres to the following layer. The location within each segment which becomes a loose inner tail when wrapped about a module is provided with a first RFID tag while other RFID tags are provided at equally spaced locations along the inner layer. Each RFID tag is provided with a unique identifier for which may be read by a RFID tag reader carried by a module handling implement having forks rotatable by reversible motors operable for rotating the module for placing the loose inner tail at a desired location relative to a cutting device for slitting the wrapping during wrapping removal. A control arrangement is coupled to the RFID tag reader and uses the information from the tag identifiers to cause the module to be rotated in a direction most suitable for optimizing placement the loose inner tail in the desired location for wrapping removal.

### FIELD OF THE INVENTION

The present invention relates to a system for handling cylindrical modules wrapped in plastic surface wrap material including specialized plastic wrapping material and handling equipment capable of rotating a supported module for orienting the module for having the wrapping removed, and, more particularly, relates to a system including plastic wrapping material embodying RFID tags for identifying the location of a loose inner tail of the wrapping material and a module handling implement including an RFID reader for identifying when the module is in a desired location for having the wrapping slit for the removal of the wrapping from the module such as a module of lint cotton, for example.

### BACKGROUND OF THE INVENTION

It is known to provide a cotton harvester with a baling chamber in which cylindrical modules of lint cotton are formed and to wrap such modules with a plastic surface wrap which acts to hold the module together and to protect the baled cotton from contaminants and moisture. One problem attendant with cotton modules wrapped with a protective layering of plastic material is the need to remove the entire wrapping from the module at the time that the module is being placed on an inlet feed floor of a cotton gin. During the process of wrapping a module or bale within the bale chamber of a module or bale forming machine, the first length of wrapping material entering the bale chamber does not bond well with the next adjoining layer of the wrap. After about six feet (two meters) of wrapping material is applied to the circumference of the module or bale, the tension and tackiness of one side of the wrapping material helps bond the inner layer to the second layer, and the second layer to the third, if more than two layers are applied. One way of removing the wrapper from the module at the gin involves slitting the wrapper at one side of the module along a line that extends parallel to the module axis. However, in order to prevent the loose inner tail from being separated from the bonded layers of the wrapping by this initial cut and then falling into the lint cotton emptied from the wrapping, it is necessary for the slitting of the wrapping to be done at a location offset from the loose tail.

U.S. patent application Ser. No. 11/928,240, filed on 30 Oct. 2007 by Noonan et al and assigned to the assignee of the instant application, discloses the idea of embodying RFID tags in the wrapping so that the location of the loose inner tail may be identified by an RFID reader placed on a module handling implement having the capability of rotating the module for placing the loose inner tail in a desired location prior to the wrapper being slit. In a second known module handling device, the RFID reader and the module slitting device are mounted adjacent each other.

One drawback associated with the wrapping material disclosed in the above-identified patent application is that, depending on the initial location of the loose inner tail of the wrapping when the module is lifted by the module handling implement, it may take substantial cycle time to properly position the module for having the wrapping slit. For example, the module handler disclosed in the patent application is equipped with an RFID reader that is positioned at the 12:00 o'clock position of the module. During the wrap removal process, the module is first rotated in one direction until the RFID tag applied to the inner loose tail is identified. However, if the initial position of the RFID tag is at an upper location of the module which is just out of view of the reader, and the module handler attachment is operated to cause the module to be rotated such that the RFID tag initially moves away from the reader, then considerable time-elapses while the module is being rotated sufficiently (nearly 180°) to bring the RFID tag within the “view” of the reader, the wrapping then being properly oriented for being slit at a bottom location of the module which is offset approximately 180° from the RFID reader. The second known module handling device, noted above, has a similar, but more severe drawback since once the RFID tag is within the view of the reader, the module has to be rotated so as to displace loose inner tail section a sufficient distance from the slitting device so that the loose inner tail section remains joined to the bonded layers of the wrapper. Another drawback is that a cotton module being rotated has a tendency to corkscrew or move axially relative to the rotating handler forks resulting in difficulties in having a repeatable control zone for the position of the module relative to the slitting device.

The problem to be solved then is that of providing a wrapping which, when applied to a cotton module, may be more quickly oriented to a desired location for being slit so as to ensure that the slitting operation does not result in the loose inner tail being separated from the remainder of the wrapping such that it enters the gin with the cotton being emptied from the wrapping.

### SUMMARY OF THE INVENTION

According to the present invention there is provided a wrapping material for large cylindrical cotton modules which avoids the aforementioned drawbacks.

An object of the invention is to provide a wrapping material which embodies RFID tags so located on each length of wrapping material required for placing a predetermined number of layers of wrapping material on the circumference of a module having a predetermined diameter that a module handling device equipped with a tag reader and the ability of rotating the module can determine the direction of rotation of the module that is the most efficient for placing the module in a desired position for avoiding cutting off the loose inner tail of the wrapping when the wrapping is slit during removal of the wrapping when the cotton is being emptied from the wrapping at the cotton gin.

The above object is achieved by providing wrapping material that embodies a plurality of separately identifiable RFID tags respectively at equally spaced locations along a length of each section of the wrapping material located for forming an inner layer of a predetermined number or wrapping layers when wrapped about a module having a predetermined diameter, with one of these tags being centered in the loose inner tail so as to identify the location of the loose inner tail, when read by the reader and with the reader being coupled in a control system for the module handling device, and with the other tags having identifiers for indicating the respective locations of the tags on the inner layer of the wrapping material and, hence, the direction that the module must be rotated in order to place the one tag within the view of the reader with the least rotation of the module.

### BRIEF DESCRIPTION OF THE DRAWINGS

FIG. 1 is a schematic top view of a length of plastic wrapping material including a plurality of segments each of a length for wrapping a cylindrical module and each embodying a plurality of RFID tags on a section adapted for forming an inner wrapping layer on a wrapped module.

FIG. 2 is a schematic perspective view, with parts removed for clarity, of a module handler in the form of a fork attachment equipped with an RFID tag reader and including a pair of module support tines formed as driven rollers, which are mounted for being moved transversely relative to each other.

FIG. 3 is a top view of the fork attachment shown in FIG. 2, but omitting the RFID tag reader support so as to expose the wrap gathering rollers together with the drive arrangement associated with the rollers.

FIG. 4 is a schematic view of the electro-hydraulic control circuit used for controlling operation of the powered rollers and for controlling the cylinders for adjusting the distance between the powered rollers.

FIG. 5 is a schematic end view of a module wrapped with a counterclockwise wound segment of the wrapping material of FIG. 1 forming three layers and being supported on the powered, cylindrical forks of the fork attachment shown in FIG. 2.

FIG. 6 is a view like FIG. 5, but depicting a module wrapped with a clockwise wound segment of the wrapping material.

### DESCRIPTION OF THE PREFERRED EMBODIMENT

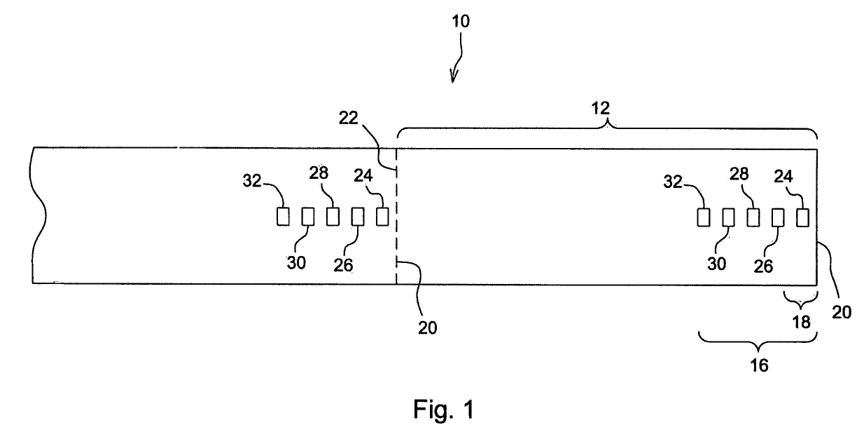

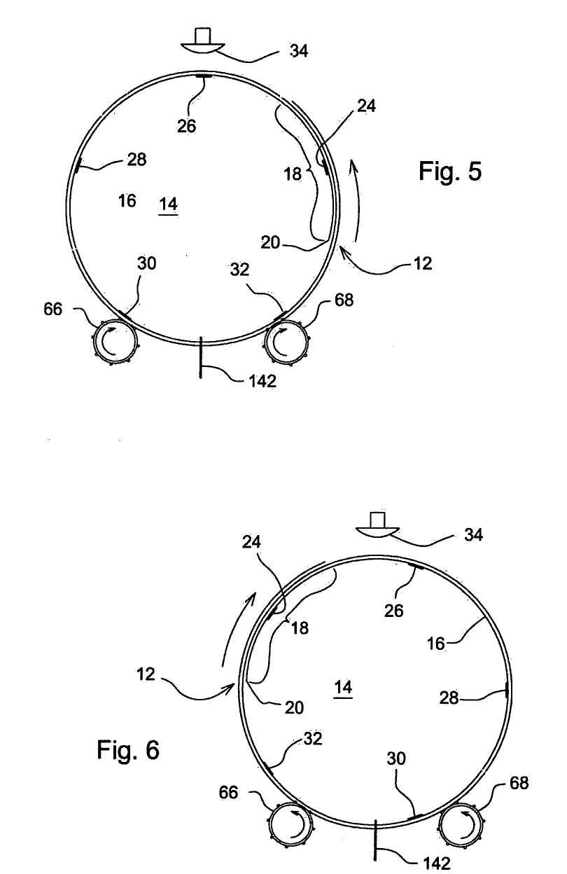

Referring now to FIG. 1, there, is shown a length of plastic wrapping material 10 formed as a sheet including a plurality of identical segments 12, each having a predetermined length sufficient for providing a desired number of wraps or layers on a cylindrical cotton module 14 (see FIGS. 5 and 6) having a predetermined diameter. As considered when wrapped about the module 14, each of the segments 12 includes an inner tail section 16 having a length forming a first layer of wrapping on the module and including a loose inner tail region 18, including an inner tail end 20, with each segment 12 disclosed here being long enough for forming three layers about the module 14 and ending in an outer tail end 22. The inner tail end 20 and outer tail end 22 are joined together prior to being separated by a cutting mechanism of a wrapping mechanism of the module forming machine. While the wrapping material 10 is shown as being a continuous sheet in the regions where the ends 20 and 22 are joined, It is to be understood that the wrapping material 10 can be formed to include perforations or glued joints between the tail ends 20 and 22, with separation being accomplished by applying tension alone, or in the case of the perforations, by using a combination of tension and cutting. How the segments 12 are joined together is not critical.

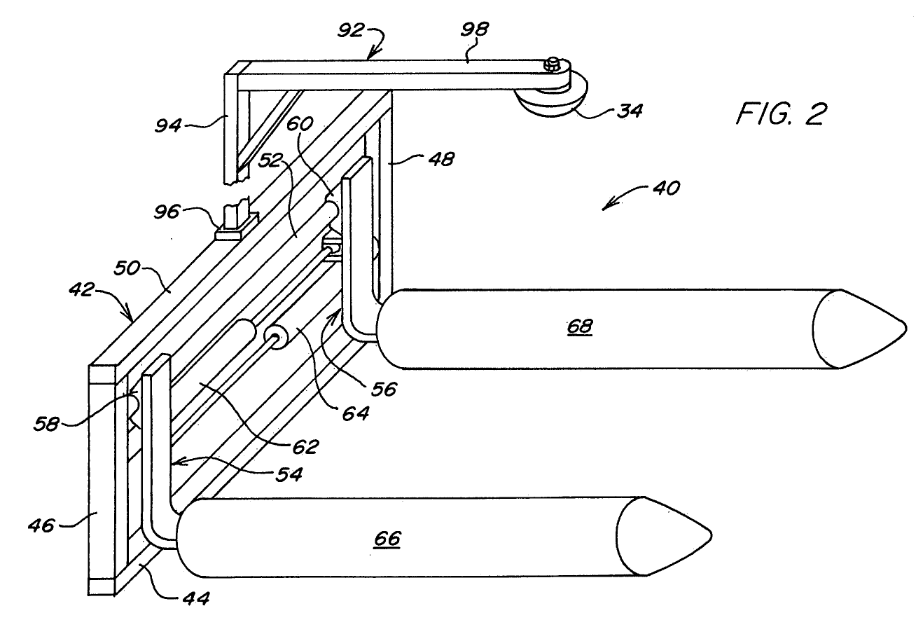

Embodied in the wrapping material 10 so as to be equally spaced in the inner tail section 16 are five of RFID tags 24, 26, 28, 30 and 32, with the tag 24 being centered in the loose inner tail region 18, and the others following serially thereafter. A different identifier is assigned to each of the five tags 24-32 of each wrapping segment 12 so that the particular region of the inner tail section 16 that is in the “view” of a tag reader 34 (FIG. 2) supported above the module 14 may be determined for a reason set forth below.

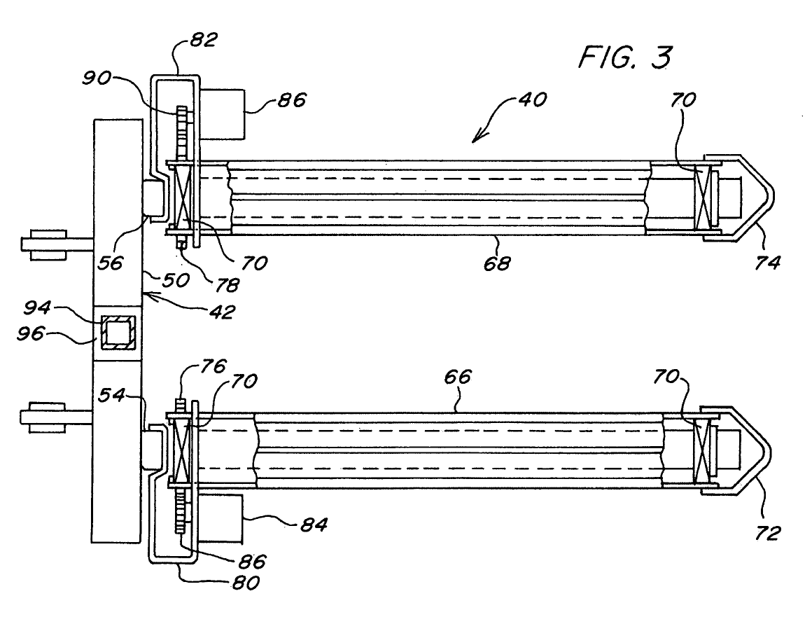

Referring now to FIGS. 2 and 3, there is shown a module handling device in the form of a loader fork attachment 40. The loader fork attachment 40 includes an upright support frame 42 which is generally of a rectangular configuration including a horizontal bottom member 44 having opposite end regions respectively fixed to lower ends of right- and left-hand side members 46 and 48. Upper ends of the side members 46 and 48 are fixed to a horizontal top member 50. A horizontal cylindrical guide rod 52 extends transversely between, and has opposite ends fixed to the side members 46 and 48. Right- and left-hand elongate fork members 54 and 56, respectively, are of a conventional configuration having respective upright rear sections respectively provided at upper, rear regions with eyes 58 and 60 that are respectively received for sliding along the guide rod 52. A first extensible and retractable hydraulic cylinder 62 has its cylinder end fixed to the right-hand side member 46 and its rod end coupled to the left-hand fork member 56. Similarly, a second extensible and retractable hydraulic cylinder 64 has its cylinder end fixed to the left-hand side member 48 and its rod end coupled to the right-hand fork member 54. Thus, it will be appreciated that the hydraulic cylinders 62 and 64 serve to effect lateral movement of the fork members 54 and 56 relative to each other so as to aid in picking up and depositing cotton modules 14, as is more fully described below.

As shown, right and left module support rollers 66 and 68, of cylindrical tubular construction, are each respectively rotatably mounted on horizontal sections of the fork members 54 and 56 by a pair of bearing assemblies 70 (shown only in FIG. 3) located one each at opposite inner end regions of the cylindrical tubular portions of each of the rollers 66 and 68 and being fixed to opposite end regions of the horizontal fork sections. Conical caps 72 and 74 are respectively provided for closing the front ends of the cylindrical tubular portions of each of the module support rollers 66 and 68 and may be secured in any known fashion (not shown), but preferably by a quick attach design such as a snap fit; for example.

A drive arrangement (shown only in FIG. 3 for the purpose of clarity) is provided for effecting selective rotation of the module support rollers 66 and 68 and includes respective driven gears 76 and 78 respectively fixed on the peripheries of the rollers 66 and 68 at end regions opposite from those engaged by the conical caps 72 and 74. Motor mounting brackets 80 and 82 are respectively fixed to, and project outwardly from, respective regions of the fork members 56 and 58 where the upright fork sections join the horizontal fork sections. Respectively mounted to the brackets 80 and 82 are identical reversible, low speed, high torque hydraulic motors 84 and 86, with the motor 84 having an output shaft carrying a drive gear 88 meshed with the gear 76 carried by the roller 66, and with the motor 86 having an output shaft carrying a drive gear 90 meshed with the gear 78 carried by the roller 68.

An RFID reader support structure 92 (shown only in FIG. 2, for the sake of clarity) includes a vertical post 94 having its lower end joined to a horizontal mounting plate 96 that is joined, as by welding, to the top of the frame top member 50 at a location midway between opposite ends of the top member 50. Joined to, and supported in cantilever fashion from a top region of the post 92 is a horizontal support member 98 which extends forwardly a distance approximately equal to one half the length of the rollers 66 and 68. The RFID reader 34 is vertically adjustably mounted to a forward end region of the horizontal support member 98 so as to be in position for reading RFID tags embodied in the wrapping material segment 12 encompassing a given cotton module 14 supported on the rollers 66 and 68, as shown in FIGS. 5 and 6.

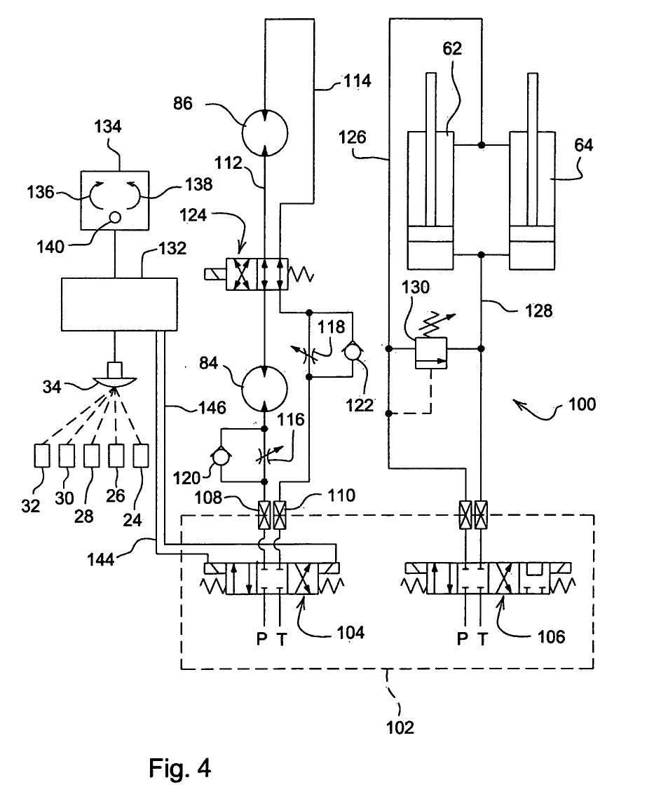

Referring now to FIG. 4, there is schematically shown a electro-hydraulic control circuit 100 for controlling the various electro-hydraulic functions associated with the loader fork attachment 40. Specifically, the vehicle (loader or tractor, for example) supporting the loader fork attachment 40 includes a hydraulic system indicated by the functional box 102 in which is embodied a three position, solenoid-operated servo control valve 104 and a four-position, solenoid-operated servo control valve 106. Each of the servo control valves 104 and 106 has pressure and return ports respectively coupled to a source of fluid pressure P and a tank or reservoir T.

The servo control valve 104 is used for controlling the reversible module support roller drive motors 84 and 86, and coupled to the servo control valve 104 by respective quick-couplers 108 and 110 are pressure/return lines 112 and 114. Located in series in the pressure/return line 112 are the motors 84 and 86, with an adjustable orifice 116 being located in series between the quick-coupler 108 and the motor 84. A similar adjustable orifice 118 is coupled in the pressure/return line 114 at a location between the quick-coupler 110 and the motor 86. Thus, the adjustable orifices 116 and 118 are respectively positioned so as to control the speeds of the motors 84 and 86 in both directions of their operation. Respective check valves 120 and 122 are coupled to bypass return flow from the motors 84 and 86 respectively around the orifices 116 and 118. Provided for selectively controlling the motor 86 for causing it to be driven in an opposite direction than the motor 84 is a solenoid-operated, two-position direction selector valve 124 coupled to the pressure/return line 112 at a location between the motors 84 and 86, and coupled to the pressure/return line 114 at a location between the motor 86 and the orifice 118. The direction selector valve 124 is shown biased to a normal position wherein it connects the motor 86 for being driven in the same direction as the motor 84, with return flow from the motor 86 passing through the check valve 122. Actuation of the solenoid of valve 124 results in the valve 124 shifting to the right, from the normal position illustrated, so as to cause the motor 86 to be driven in a direction opposite to that of motor 84, with return flow from the motor 86 again flowing through the check valve 122.

The servo control valve 106 is used for controlling the operation of the fork adjustment cylinders 62 and 64, and is connected to a first pressure/return line 126 coupled to the rod ends of the fork adjustment cylinders 62 and 64, while a second pressure/return line 128 is coupled to a cylinder end of each of the cylinders. An adjustable pressure relief valve 130 is coupled between the pressure/return lines 126 and 128.

A manually operated control arrangement (not shown) of a conventional design including electrical switches, for example, can be used for selectively controlling the operation of the valves 104, 106 and 124.

A programmable computer 132 is coupled to the RFID tag reader 34 for receiving and processing the tag identification information read by the reader. Also coupled to the computer 132 is an input/display device 134 which may be used to pre-program pertinent information, such as the direction (clockwise or counterclockwise) in which the wrapping material segment 12 has been wrapped about the module 14, into the computer 132, with the device 134 being capable of operating in response to signals received from the computer to, for example, light direction indicator arrows 136 and 138 for indicating the direction in which the module 14 must be rotated to minimize the amount of rotation of the module 14 in order to place it in a desired location for removal of the wrapping. A stop rotation signal is sent to the input/display device 134 and illuminates a stop rotation light 140 when the tag reader 34 senses a tag which indicates the module is in, or approximately in, a desired location for having the wrapping slit.

Referring now to FIGS. 5 and 6, there is shown the wrapped module 14 supported on the powered rollers 66 and 68 of the loader fork attachment 40. The module 14 illustrated In FIG. 5 has been wrapped while turning counterclockwise, while the module 14 in FIG. 6 has been wrapped while turning clockwise. Thus, in FIG. 5, the RFID tags 26-32 trail the RFID tag 24 and, hence, the loose inner tail 18, serially in the counterclockwise direction, and in FIG. 6, the RFID tags 26-32 trail the RFID tag 24 in the clockwise direction. Since the tags 24 through 26 are spaced equally from each other, adjacent tags are located approximately 72° from each other about the axis of the module 14.

In operation, assuming that the wrapping is to be removed from the wrapped module 14 by first slitting the wrapping lengthwise of the module by a stationary or rotating cutter 142 located at the end of a dump zone of a cotton gin receiving floor, the module 14 will first be rotated by the rollers 66 and 68 to place the inner tail 18 approximately opposite the location of the cutter 142. Assuming the module 14 to be the one depicted in FIG. 5 and that the operator has somehow become aware of the fact that the wrapping was applied in the counterclockwise direction (note that this direction changes, from the view point of an operator, depending on which end of the module 14 is toward the operator when picked up by the fork attachment 40), the operator will use the input/display device 134 to input this information into the computer 132. If the initial position of the module 14 is that shown in FIG. 5, the RFID tag 26 will be adjacent to, and within a read zone where it will be read by, the tag reader 34. The read information will be sent to the computer 132 and contains the unique identifier associated with the tag 26. The computer 132 will already have been pre-programmed for recognizing the unique identifiers of the tags 24-32 and will associate the tag 26 with its location along the inner layer 16 of the wrapping material segment 12. Since the tags 24-32 are arranged serially in the counterclockwise direction, the computer will recognize that the read tag 26 is next to, and counterclockwise from, the tag 24. The computer 132 will then send a signal to the input/display device 134 which causes the rotation direction indicator arrow 138 to be lit informing the operator that the servo control valve 104 should be actuated to effect counterclockwise rotation of the motors 84 and 86 and, hence, clockwise rotation of the rollers 66 and 68, and counterclockwise rotation of the module 14. Once the motors 84 and 86 have been actuated to effect clockwise rotation of the rollers 66 and 68, as shown in FIG. 5, the rollers will, rotate the module 14 counterclockwise approximately 72° thus bringing the RFID tag 24 into the read zone beneath the reader 34 where it is read. A signal representing the unique identifier of tag 24 acquired by the reader 34 will be sent on to the computer 132 which will determine that the loose inner tail 18 is properly located for having the wrapping on the module 14 slit by the cutter 142. The computer 132 will send a stop rotation signal to the input/display device 134 which effects illumination of the stop indicator light 140, whereupon the operator interrupts current flow to the energized-solenoid of the control valve 104 so that it returns to neutral, with rotation of the motors 84 and 86 ceasing. The wrapping on the module 14 may then be slit by driving the vehicle supporting the fork attachment 40 forwardly so that the wrapper at the bottom of the module 14 is slit lengthwise along a line extending parallel to a central axis of the module.

If the initial location of the module 14 is such that a region of the module located between the RFID tags 28 and 30 is located below the reader 34 with neither of the tags 28 or 30 being located in the read zone of the reader, the operator may effect either clockwise or counterclockwise rotation of the module 14 to bring one or the other of the tags 28 into view of the reader. Assuming that the operator effects counterclockwise rotation of module 14, the tag 28 will rotate into view of reader 34 and it will acquire the unique identifier of tag 28 and send a signal relating to the identifier to the computer 132, which will compute that the minimum amount of additional rotation required to bring the tag 24 into view of the reader 34 is approximately 144° counterclockwise (clockwise rotation would require approximately 216° of rotation). Upon making this computation, the computer 132 will operate to send a signal to the input/display device 134 which causes the counterclockwise rotation-indicator arrow 138 to be illuminated, informing the operator that the servo control valve 104 needs to be actuated to cause counterclockwise rotation of the module 14. As with the first example, rotation of the module 14 will continue until the tag 24 comes into view of the reader 34, with the read information resulting in the stop rotation indicator light 140 being lit. A total of approximately 180° of rotation is required to place the module 14 in the desired location for having the wrapping slit.

If the initial position of the module 14 is the same as that described in the immediately preceding example, wherein the reader 34 is above a region of the module located between the RFID tags 28 and 30, but the operator first effects rotation of the module in a clockwise rotation, the tag 30 will be the one that first comes into the view of the tag reader 34. The unique identifier of the tag 30 will be acquired by the reader and a corresponding signal will be sent on to the computer 132 which computes that the minimum rotation of the module required to, bring the RFID tag 24 into view of the reader 34 is approximately 144° clockwise and a signal consistent with this direction is sent to the input/display device 134 which lights the clockwise direction of rotation arrow 136, thereby informing the operator to actuate the servo control valve 104 so as to effect clockwise rotation of the module 14. Again, once started, rotation continues until the RFID tag 24 passes beneath and is sensed by the RFID tag reader 34.

In the event that the operator does not know whether the wrapping material segment 12 is wrapped clockwise or counterclockwise about the module 14, the computer 132 is able to discern this according to the sequence in which consecutive RFID tags are read during rotation of the module 14. For example, assuming the module 14 is in an initial, position, such as that shown in FIG. 6, wherein a region of the module 14 located between the tag 24 and 26, with the tag 26 being in the read zone of the tag reader 34, and the operator effects counterclockwise rotation of the module 14, the RFID tag 26 will move beneath and out of the read zone of the reader, with the tag 28 then moving into the read zone. The reader 35 will have acquired the information identifying the tags 26 and 28 and the computer 132 will receive this data from the reader 34 and determine that the identifier for tag 28 follows that for tag 26, and that the wrapping material segment 12 is thus wrapped clockwise about the module 14. Using this information, the computer 132 will further determine that the minimum rotation of the module 14 required for placing the RFID tag 24 within the read zone beneath the RFID reader 34 is approximately 144° clockwise. Therefore, the computer 132 will send a signal to the input/display device 134 which effects illumination of the direction indicator light 136. Thus, in this example, the module 14 underwent a total of approximately 220° in order to place it in a correct position for having the wrapping removed.

It is noted that an automatic operation mode may be keyed into the computer 132 from the input/display device 134 in which case, in addition to the signals for effecting illumination of one or the other of the direction arrows 136 and 138, the computer 132 can send respective signals over leads 144 and 146 to automatically energize the servo control valve 104 for causing the module 14 to be rotated in the direction for minimizing its angular movement to the desired position for having the wrapping slit during the process of removing the wrapping from the module 14. All that is needed for starting the process of positioning of the module 14 for having the wrapping slit is for the operator to choose the initial direction of rotation of the module by actuating the servo control valve 104.

It will be appreciated that for different module handlers having the RFID tag reader 34 located at locations other than 180° from the desired location for slitting the wrapping, the computer 132 can be programmed for accommodating this. For example, if the reader 34 is located adjacent a bottom region of the module 14, it would be necessary to rotate the module 14 approximately 180° after the RFID tag 24 is moved to the read zone so that the loose inner tail 18 is opposite the desired cutting zone.

Having described the preferred embodiment, it will become apparent that various modifications can be made without departing from the scope of the invention as defined in the accompanying claims.

1. In a plastic wrapping material including a plurality of end-to-end segments each having a length sufficient for wrapping a module having a given diameter with a predetermined number of layers including at least inner and second layers, and wherein a section of each segment adapted for forming said inner layer includes an inner tail which does not adhere to second layer, and a first RFID tag being located on said inner tail, the improvement comprising: said section of each segment adapted for forming said inner layer being provided with a plurality of further RFID tags being located on said section, with said first RFID tag and plurality of further RFID tags each being spaced equally from each other along approximately an entire length of said section, and each first, and plurality of further, RFID tags being provided with a unique identifier, whereby, when a given segment of said wrapping material is wrapped about a given module an RFID tag reader will be able to discern a respective location for each of said first and plurality of further RFID tags about a circumference of said given module.

2. The plastic wrapping material, as defined in claim 1, wherein said plurality of further RFID tags constitutes at least three tags.

3. In a cylindrical cotton module having a circumference wrapped with at least first and second layers of plastic wrapping material, with said first layer of plastic material including an inner tail which is in contact with, but not adhered to, said second layer of plastic material, and a first RFID tag being located on said inner tail, the improvement comprising: a plurality of further RFID tags located along approximately an entire length of said first layer of wrapping material, with said first and plurality of further RFID tags being equally spaced from each other; and said first and plurality of further RFID tags each being respectively provided with a unique identifier, thereby permitting the location of each RFID about said circumference of said module to be discerned with an RFID reader

4. The cotton module, as defined in claim 3, wherein said plurality of further RFID tags constitute at least three tags.

5. A cylindrical module handling device having a module support arrangement comprising at least first and second powered rollers for supporting a cylindrical module and including at least first and second reversible motors respectively coupled to said at least first and second powered rollers for effecting rotation of said powered rollers; an electro-hydraulic control circuit including a solenoid-operated servo control valve coupled to said first and second reversible motors for selectively effecting rotation of said, first and second motors in opposite directions; an RFID reader elevated above said first and second powered rollers and adapted for reading a plurality of RFID tags incorporated along a length of wrapping material forming a first layer of material enveloping a cylindrical module supported by said at least two powered rollers; said control circuit embodying a computer coupled to said RFID tag reader and to said servo control valve and being operable for receiving RFID tag information relating to the location of a given one of said plurality of tags as said given one of the tags is positioned adjacent said RFID tag reader and for sending a control signal to said servo control valve based ion this information so as to cause said reversible motors to rotate in a direction for optimizing, rotation of the module to a desired position.
